(19) United States
(12) Patent Application Publication
(10) Pub. No.: US 2019/0194529 A1
(43) Pub. Date: Jun. 27, 2019

(54) SMART PROPPANT PLATFORM TECHNOLOGY

(71) Applicants: HiFunda LLC, Salt Lake City, UT (US); University of Utah Research Foundation, Salt Lake City, UT (US)

(72) Inventors: Kyu-Bum Han, Salt Lake City, UT (US); James J. Steppan, Park City, UT (US); Balakrishnan Nair, Sandy, UT (US); John McLennan, Salt Lake City, UT (US); Taylor D. Sparks, Salt Lake City, UT (US)

(21) Appl. No.: 16/229,398

(22) Filed: Dec. 21, 2018

Related U.S. Application Data
(60) Provisional application No. 62/609,166, filed on Dec. 21, 2017.

(51) Int. Cl. C09K 8/80; C04B 35/64; C09K 8/584; E21B 43/267

(52) U.S. Cl. CPC C09K 8/805; C04B 35/64; C04B 2235/963; E21B 43/267; C09K 8/584

(57) ABSTRACT

A delivery vehicle is used in a smart proppant platform technology. The delivery vehicle includes a porous substrate and an active agent that interacts with at least one constituent in an operating environment of a target location in which the delivery vehicle is deployed. The active agent changes physical or chemical characteristics of the constituent to facilitate a beneficial effect. A non-polymeric encapsulating coating is maintained until the delivery vehicle reaches the target location, wherein the operating environment of the target location causes the encapsulating coating to dissolve and release the active agent into the operating environment of the target location to facilitate the beneficial effect. In one disclosed example, the proppant is designed to maintain the opening of a hydraulically induced fracture in a subterranean formation, while also allowing for the controlled delivery of active agents. It may be used to enhance the recovery of oils and gases.

### CROSS-REFERENCE TO RELATED APPLICATION

This application claims the benefit of U.S. Provisional Application No. 62/609,166, filed Dec. 21, 2017, which is incorporated by reference.

### FIELD OF THE INVENTION

The present invention relates generally to a porous substrate delivery vehicle that transports and releases an active agent into a target location, and more particularly to a proppant designed to maintain the opening of a hydraulically induced fracture in a subterranean formation, while also allowing for the controlled delivery of active agents.

Although the present invention was initially developed to enhance the recovery of oils and gases, the platform technology also has broad application in other fields. For example, the delivery of an active agent using a platform comprising a delivery vehicle and an active agent component may also be used for fluid filtration, contaminant removal and for the targeted delivery of subterranean well closure materials.

### BACKGROUND OF THE INVENTION

Hydraulic Fracking:

Continuous oil and natural gas production in the United States and around the world have resulted in a decline of conventional resources (i.e. pools in which wells can be drilled so that oil and natural gas flows naturally or can be pumped to the surface). Essentially, almost all the oil and natural gas that can be produced from conventional sources is already being exploited. With new technologies, such as horizontal drilling, oil and natural gas producers can produce “unconventional” oil and natural gas resources that could not be utilized previously.

Oil and natural gas from these unconventional resources do not flow naturally through the rock, making them much more difficult to produce. Unconventional resources often have low permeability rock where the pores containing hydrocarbons are poorly connected, making it difficult for oil and natural gas to move through the rock to the well. Therefore, the industry has developed techniques, such as hydraulic fracking, to release the hydrocarbons from these disconnected pores to access the wellheads. During a hydraulic fracturing operation, a fluid such as water or oil is pumped into the reservoir at a high flow rate and at sufficiently high pressure to cause cracking in the reservoir rock.

These fractures in the rock act as channels that enhance the flow of oil and/or gas to the wellbore. Without any additional measures taken, these fractures tend to close in the absence of hydraulic pressure. In order to prevent this from happening, proppants are injected with the fracking fluid, which remain in place to prevent fractures from closing after the removal of hydraulic pressure and to permit free flow of the oil and/or gas being extracted.

A proppant is a solid material, typically sand, treated sand or man-made ceramic materials, designed to keep an induced hydraulic fracture open, during or following a fracturing treatment. Sand is the most commonly used proppant as it is about 10 times less expensive than ceramic proppants. However, sand can withstand closure stresses only up to 6,000 psi, while ceramic proppants are capable of withstanding very high closure stresses of 8,000 psi or greater, which are typical of tight formations. Another key advantage of ceramic proppants is that they can be customized for a specific purpose. For example, roundness and sphericity are significant factors for improving hydrocarbon permeability, quantified as the “conductivity” of a proppant.

For example, a spherical proppant was found to increase conductivity by 37% while rod-shaped proppants increased it by 48%. The density of proppant can be customized from high to low depending on the application. Lightweight proppant, for example, can be easily fabricated by using various materials such as walnut shell, thermoplastic alloy, porous ceramics, hollow glass sphere, and many others. Lightweight proppant is desirable in tight formation reservoir which has low permeability. Viscous fluid systems such as slick water and gelled fluid are employed to develop a fracture network in tight formations. Due to needing such viscous fluid systems, only lightweight proppant can be transported deep into the fracture network.

Even with hydraulic fracking, there are other problems to overcome, including reservoir pressure and low flowback water after the hydraulic fracturing. The high closure stress is caused by the wells being located at great depths below 6,000 ft. For example, the Marcellus shale gas is located in 4,000 ft.-8,500 ft. depth. Such depths generate very high reservoir pressures (>7,000 psi) and result in extremely low permeability (<0.1 mD) leading to very flow rates of oil or gas. Since oil and/or gas must flow through the fractures in order to be produced, proppant technologies that can enhance flow through the fractures would directly result in higher production rates.

The known methods and proppants used in the hydraulic fracturing process have many drawbacks. For example, even if lightweight proppants are used for the opening of hydraulic fractures, significant amount of fracturing fluid is lost during hydraulic fracturing process. This phenomenon inhibits gas production because the fluid blocks the oil and/or gas flow by being trapped in capillaries of rocks. Thermal and chemical treatments have been employed to solve the problem, but these approaches have generally not been successful at recovering the trapped fracturing fluid and are not considered environment-friendly. To enhance fracturing fluid recovery, introducing a surfactant can be a good option to reduce capillary force within tight formation. By adding surfactants, the interfacial tension of fluid can be reduced and the trapped fluid can exit the capillary more easily. One of the main problems with the surfactant approach is low injectivity as many surfactants adsorb rapidly within the first few inches of the formation. Accordingly, the surfactants, mixed in the fracturing fluid, have difficulty in being distributed effectively deep in the wells during fracturing.

Moreover, while vast amounts of coalbed methane are proven in the United States, the conventional extraction methods have economic difficulties due to the low permeability and rapid depletion of the absorbed methane.

Therefore, high performance proppants that can be dispersed into tight cracks effectively and operate efficiently under subterranean conditions for the life of the well, while simultaneously offering other benefits that can simultaneously improve production would be game-changing.

### SUMMARY OF THE INVENTION

The disclosed invention relates to a smart proppant platform technology. The smart proppant includes one or more of delivery vehicles. Each delivery vehicle includes a porous substrate, an active agent, and a non-polymeric encapsulating coating. The active agent interacts with at least one constituent in an operating environment of a target location in which the delivery vehicle is deployed in such a way as to change physical or chemical characteristics of the at least one constituent so as to facilitate a beneficial effect. In one disclosed embodiment, the constituent is oil or natural gas in a hydraulically fractured subterranean feature. In another disclosed embodiment, the constituent is unwanted environmental chemicals or materials, such as fluorinated chemicals, solvents, and surfactants.

Some non-limiting examples of beneficial effects include enhancing the recovery of oils and gases from subterranean formations, fluid filtration, contaminant removal, and for the targeted delivery of subterranean well closure materials. For instance, a beneficial effect may include a change to physical or chemical characteristics of the oil or gas to facilitate easier extraction to the surface. Another beneficial effect may include remediation of fluorinated chemicals, solvents, and surfactants. Yet another beneficial effect may include capturing or removing contaminants from a liquid.

Non-limiting examples of active agents include surfactants, biosurfactants, chelants, chemically active agents, biologically active agents, catalysts for an in-situ reaction, reactants for an in-situ reaction, or an environmentally beneficial chemical.

The non-polymeric encapsulating coating is maintained until the delivery vehicle reaches the target location. At the target location, the operating environment causes the encapsulating coating to dissolve and release the active agent into the operating environment to facilitate the beneficial effect. Non-limiting examples of encapsulating coatings include one or more of the following: a time release encapsulating coating, a plasma spray water soluble silicate coating, an oil soluble coating, a temperature sensitive coating, or an inorganic soluble coating.

The disclosed invention further includes a method for fabricating a smart proppant delivery vehicle. The disclosed method includes mixing at least one oxide material and at least one mineral in the form of a slurry. In one non-limiting example, the oxide material comprises iron oxide (Fe₂O₃) and the mineral comprises an aluminum silicate mineral such as kaolinite. The slurry is dried to form a dried powder that is subsequently tumbled to make substantially spherical particles. At least one other oxide material is mixed with the substantially spherical particles so as to form a coating of the other oxide on the substantially spherical particles. In a non-limiting embodiment, the other oxide may comprise alumina. The coated spherical particles are sintered in a furnace with a reducing atmosphere at an elevated temperature for a predetermined period of time. Non-limiting examples of a reducing atmosphere include a suitable H₂/H₂O or CO/CO₂ mixture. The sintered substantially spherical particles are cooled to room temperature and immersed in a solution comprising an active agent of interest or a precursor that can form an active agent. A non-polymeric coating is applied to encapsulate the particles and form the smart proppant as described above.

### BRIEF DESCRIPTION OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 is a cross-sectional view of an embodiment of the Smart Proppant Platform Technology;

FIG. 2 is a cross-sectional view of a porous substrate used in one or more embodiments of the Smart Proppant Platform Technology; and

FIG. 3 is a schematic of a polymerization reaction used to produce the encapsulating coating used in one or more embodiments of the Smart Proppant Platform Technology.

### DESCRIPTION OF THE INVENTION

In one or more embodiments, the present invention provides for the targeted delivery and controlled release of one or more active agents using a porous substrate as a delivery vehicle. Specific embodiments of the present invention may comprise: a porous substrate, which may be tailored in terms of porosity, surface area, proppant particle size, crush strength, and surface modification; a chemically or biologically active agent; and a time-release polymeric or inorganic encapsulant.

A detailed description of embodiments of the present invention will now be given with reference to the Figures. It is expected that the present invention may take many other forms and shapes, hence the following disclosure is intended to be illustrative and not limiting, and the scope of the invention should be determined by reference to the appended claims. The description may use perspective-based descriptions such as up/down, back/front, left/right, top/bottom, and distal/proximal. Such descriptions are merely used to facilitate the discussion and are not intended to restrict the application or embodiments of the present invention. The following disclosure of the present invention may be grouped into subheadings. The utilization of the subheadings is for convenience of the reader only and is not to be construed as limiting in any sense.

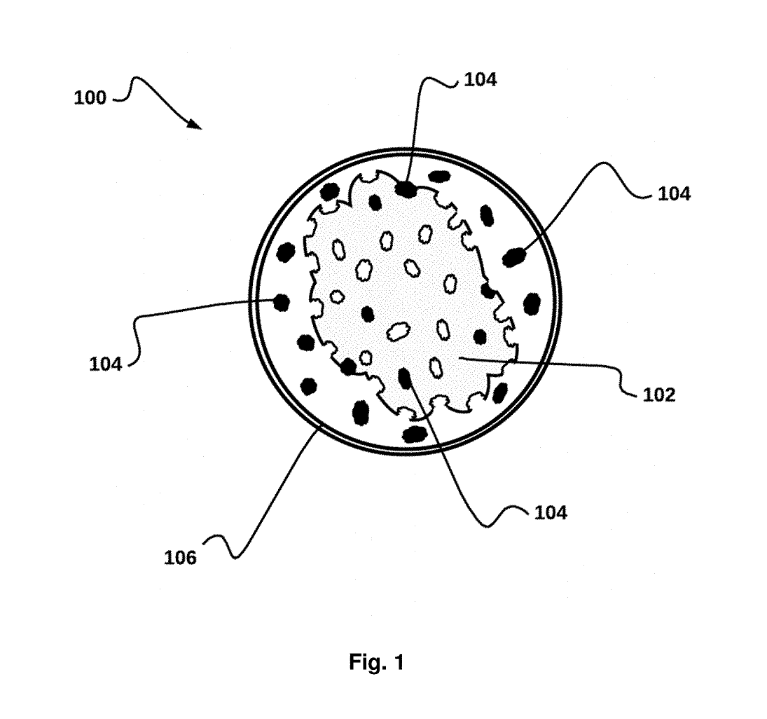

FIG. 1 depicts a cross-sectional view of an embodiment of the smart proppant platform technology 100. The smart proppant platform technology 100 comprises a porous substrate 102, an active agent 104, and an encapsulating coating 106.

Porous Substrate:

In some embodiments, which may be used for hydraulic fracturing, the porous substrate 102 is a proppant. A proppant is a solid material, typically sand, treated sand or man-made ceramic materials, designed to keep an induced hydraulic fracture open, during or following a fracturing treatment. Ceramic proppants deliver significant technological advantages over frac sand, which facilitates adoption. Increased strength often comes at a cost of increased density, which in turn demands higher flow rates, viscosities or pressures during fracturing, which translates to increased fracturing costs, both environmentally and economically.

A proppant may be characterized based on its physical measurements, such as size, roundness and sphericity, bulk density, or microstructure characterization. Additionally, a proppant may be characterized based on its chemical and physical resistance measurements, such as crush resistance, acid solubility, and turbidity. The specific definitions and procedures for classifying these characteristics may be established by the International Organization for Standardization (ISO).

In some embodiments, the proppant may be selected or designed to achieve a desired strength, mesh particle size, porosity, bulk density or average pore size.

In one embodiment, the proppant may be a thermoplastics or resin-coated proppant. A thermoplastics or resin-coated proppant may be creating using walnut shells that are coated with resin to increase the strength and crush resistance or durability while reducing the density of the proppant. In an alternate embodiment, the selected proppant is designed utilizing a thermoset polymer mixed with a nanofiller such as styrene-divinylbenzene copolymer or styrene-ethylvinylbenzenedivinylbenzene terpolymer.

In other embodiments, a lightweight porous ceramic proppant may be fabricated by starting with a mixture of iron oxide (Fe₂O₃) and kaolinite. The porosity and strength of the proppant may be tailored based on the concentrations of iron oxide and kaolinite, and the process conditions. For example, a lightweight ceramic proppant may be produced by reducing the mixture of iron oxide and kaolinite using a suitable H₂/H₂O or CO/CO₂ mixture to control partial pressure of oxygen, creating internal porosity through the reduction of iron oxide to iron, resulting in reducing bulk density. The resulting iron metal enhances the high strength of kaolinite, effectively forming a ceramic-metal (cermet) composite. The desired size distribution can be achieved through a slurry process. To vary the pore sizes in the proppant, different amounts of iron oxide may be added to the kaolinite. Furthermore, different size of iron oxide raw powder may also be used to change the pore size.

In one non-limiting embodiment, the lightweight ceramic proppant was fabricated by adding iron oxide to kaolinite and mixed in a cylindrical chamber. To make the slurry, water and zirconia media may be added to the chamber and the mixture may be milled at 60 rpm at room temperature for 24 hours and then dried. Then, the dried powder may be loaded into a specially designed tumbler that has been developed to make spherical particles. The spherical particles may be selected by size using sieves. The mixture may be sintered in a high temperature atmosphere controlled tube furnace at temperatures from up to 1500° C. for 40 minutes.

In another non-limiting embodiment, the ceramic proppant may be fabricated with a 20/40 mesh particle size and ˜35 vol. % porosity, bulk density of ˜1.4 g/mL, and an average pore size of ˜50 μm. This specific lightweight ceramic proppant may be specifically designed to pass standard crush and acid resistance tests (ISO 13503-2:2006). In addition, this lightweight ceramic proppant may be specifically designed to meet the Krumbein-Sloss shape factor recommended by the American Petroleum Institute (API RP 19C) by having the desired values of roundness and sphericity greater than 0.7.

In some preferred embodiments, the proppant may have the following characteristics:

TABLE 1
The targeted standard for lightweight proppant

| | Roundness and | Bulk | Crush | Acid | |
|---|---|---|---|---|---|
| Size | sphericity | density | resistance | solubility | Turbidity |
| 20/40 | >0.7 (both) | <1.4 g/mL | <7 wt. % | <2 wt. % | <150 NTU |
| mesh | | | | loss | |

In some embodiments, the surface of the porous substrate 102 may be modified. In some embodiments, the surface modifications may allow for improved proppant distribution, deeper proppant penetration within the complex fracture network, increased proppant pack volume, and increased maximum proppant concentration that can be placed.

In other embodiments, the porous substrate 102 may be modified with a surfactant.

In other embodiments, which may be used to deliver active agents to remove hazardous or unwanted species, the porous substrate 102 may be a porous ceramic substrate. In other embodiments, which may be used to deliver active agents to seal a subterranean oil or gas well, the porous substrate 102 may be a porous ceramic substrate. In yet other embodiments, which may be used to deliver active agents that react with contaminants, the porous substrate 102 may be a porous ceramic substrate. A porous ceramic substrate may be selected from zeolite, fly ash, sand, or a similar microporous material.

In some embodiments, the surface of the porous substrate 102 may be modified. In some specific embodiments, the proppant may be chemically surface modified by attaching a chelant (amine, polyamidoamine, azole, cyclodextrin, covalent organic frameworks, or other) to selectively capture metal ions, metal particles, and dissolved metal particles in solution. In one embodiment, the proppant may be chemically surface modified by attaching a chelant (amine, polyamidoamine, azole, cyclodextrin, covalent organic frameworks, or other) selected to capture dissolved metal ion contaminants In one specific non-limiting embodiment, a chelant selected to capture copper ions in solution may be utilized to purify hydrocarbon fuel contaminated with copper ions. In another non-limiting embodiment, a chelant is selected for the sequestration and remediation of explosives.

In some embodiments, the fabrication process for the porous substrate 102 may include one or more pore formers.

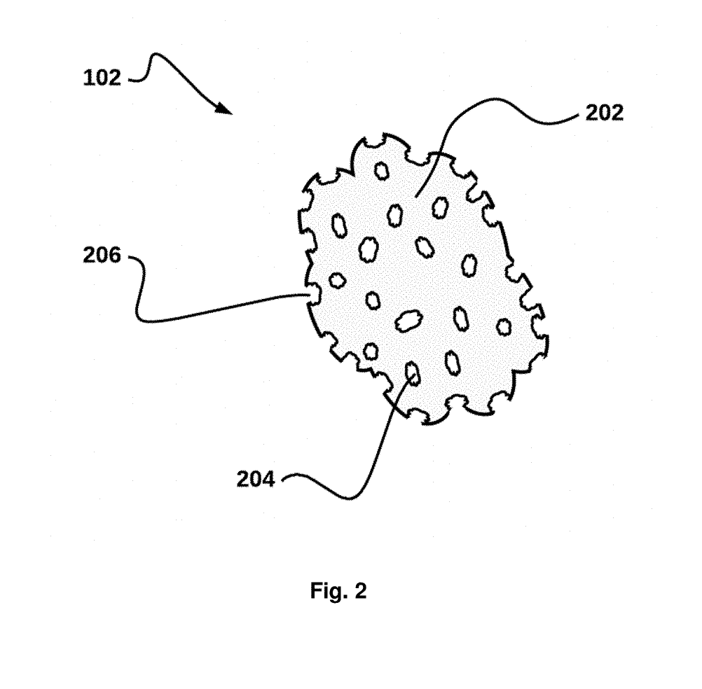

FIG. 2 depicts a cross-sectional view of the porous substrate 102 of an embodiment of the smart proppant platform technology 100. The porous substrate 102 may comprise a solid core 202, inner pores 204, and surface pores 206. In some embodiments, the solid core 202 is formed by mixing iron oxide (Fe₂O₃) with kaolinite. In some embodiments, the inner pores 204 are created by mixing iron oxide to kaolinite at a low partial pressures of oxygen and high temperatures. In some embodiments, the size of the inner pores 204 are 24 μm±12 μm. In some embodiments, the inner pores 204 cause the porous substrate 102 to have a porosity of 29.3% and a density of 1.4 g/mL. In some embodiments, the surface pores 206 are created by coating the solid core 202 with aluminum oxide. In some embodiments, the size of the surface pores 206 are 8 μm±3 μm. In some embodiments, collectively, the inner pores 204 and surface pores 206 cause the porous substrate 102 to have an open porosity of 36% and density of 1.7 g/mL.

Active Agent:

The active agent 104 may include one or more of the following additives: a chemically active agent, a surfactant, a bio-surfactant, a catalyst for an in-situ reaction, a reactant for an in-situ reaction, an environmentally beneficial chemical, or a sequestering agent.

In some embodiments, the active agent 104 may be infused in the inner pores 204 of the porous substrate 102. In some embodiments, the active agent 104 may be infused in the surface pores 206 of the porous substrate 102. In some embodiments, the active agent 104 may be wholly encapsulated within the encapsulating coating 106.

In some embodiments, which may be used to improve oil and gas well production, the active agent 104 is a surfactant. In these embodiments, the surfactant may allow for improved proppant distribution, deeper proppant penetration within the complex fracture network, increased proppant pack volume, and increased maximum proppant concentration that can be placed. In some specific embodiments, the surfactant may be infiltrated into the porous substrate 102 using a vacuum infiltration process. To infiltrate the surfactant material into the fine pores of the porous substrate 102, the porous substrate 102 may be placed inside a vacuum chamber, pumped down to a vacuum level of 100-300 millitorr and the valve closed to isolate the chamber from the pump. A dilute solution of the surfactant may then be released into the chamber, resulting in the surfactant being able to fill the empty pore space of the porous substrate 102.

In other embodiments, which may be used to cleanup chemically-contaminated waste streams or aquifers, the active agent 104 may be a biological or chemical agent that reacts with a particulate or dissolved contaminant. In some embodiments, the active agent 104 may be a chelant (amine, polyamidoamine, azole, cyclodextrin, covalent organic frameworks, or other).

In some embodiments, which may be used to seal a well, the active agent 104 may be a coagulating, bonding or solidifying agent that forms an effective blockage in the well that prevents the effective flow of gases and oils. Organic sealants include: 1 or 2-part epoxy, polyurethane, polyacrylate, silicone, nitrile, polychloroprene, fluorocarbon, tetrafluoroethylene propylene, and inorganic sealants include: cement, insoluble or sparingly soluble glasses. In both cases, the proppant will be incorporated into the seal providing additional strength and robustness.

In yet other embodiments, which may be used to remove contaminants from a liquid, the active agent 104 may selected to capture both the particles and dissolved contaminants. In some specific embodiments, the active agent 104 is a chelant (amine, polyamidoamine, azole, cyclodextrin, covalent organic frameworks, or other) to capture both metal particles and dissolved metal ions in solution, such as copper particles and dissolved copper ions in a liquid fuel. In these specific embodiments, the smart proppant platform technology 100 accomplishes copper removal via physical filtration, physisorption, and chemisorption and fixation.

Encapsulating Coating:

The encapsulating coating 106 is configured to dissolve over time or under desired conditions to expose or release the active agent. The encapsulating coating may include one or more of the following encapsulating coatings: a plasma spray H₂O-soluble silicate coating that has high solubility in temperature water (˜150° C.), an oil soluble coating, an H₂O-soluble polymeric coating such as calcium alginate, a temperature-sensitive coating that melts at a desired temperature and H₂O-solubility (i.e. high molecular weight polyethylene glycol), and an inorganic soluble coating such as phosphate-based soluble glasses, water soluble minerals, aluminosilicates, CaO, and MgO.

In some embodiments, which may be used for hydraulic fracturing, the encapsulating coating 106 may release the active agent 104 by dissolving after the smart proppant platform technology 100 has been carried down with the fracking fluid to a desired location in the subterranean formation. In some embodiments, the release of the active agent 104 from the encapsulated proppant may occur rapidly or occur slowly over the useful life of the well. In some embodiments, the release of the active agent 104 may be time dependent or based on environmental factors such as pressure of temperature. In some embodiments, the encapsulating coating 106 may be selected to maintain the coating until it reaches a target depth in the rock strata. In some embodiments, the encapsulating coating 106 may release the active agent 104 at a defined rate once the smart proppant platform technology 100 has reached a desired temperature within the rock environment. As discussed above, the specific active agents 104 may be selected based on its ability to improve the production of oil and natural gas from a fractured subterranean formation.

In some embodiments, the encapsulating coating may be a hydrogel containing a selected bacteria that is dried in air to become a thin film. The coating preserves the bacteria. The preservation was proven by growing the bacteria from the hydrogel from the thin film coated proppant.

In some specific embodiments, the encapsulating coating 106 may be created by adding the porous substrate 102 with infused active agents 104 (methanogens) to a calcium lactate solution. Specifically, the encapsulating coating 106 may be achieved by dripping the mixture using a 200 μL syringe into 10 mL of sodium alginate solution while stirring at 300 rpm. By dripping small droplets into a highly-agitated solution the agglomeration of individual particles may be prevented, resulting in uniform coatings.

In some embodiments, the thickness of the calcium-alginate polymer encapsulating coating 106 is controlled by the reaction time. In some embodiments, the synthesis time may be varied from 0 to 300 seconds. In these specific embodiments, the thickness of the encapsulating coating 106 may range from 0.8 to 1.3 mm. Additionally, in these embodiments, the total particle size for the smart proppant platform technology 100 may range from 2.4 to 3.0 mm.

In other embodiments, which may be used to deliver a surfactant deep into the well, the encapsulating coating 106 may be created by injecting fine proppant particles with calcium lactate into the polymerization tank, reacting the calcium lactate with sodium alginate to form the calcium alginate hydrogel, and washing in water. In specific embodiments, this encapsulating coating 106 may be achieved by using an ultrasonic spray nozzle that is capable of producing a fine mist of the proppant particle/alginate mixture that may be sprayed into a reaction vessel containing the sodium alginate solution. Moreover, the vessel may have means for vigorous stirring and agitation to prevent the agglomeration of the viscous hydrogel calcium alginate reaction product. Finally, once the liquid in the reaction vessel reaches a high solids content loading the solution/mixture may be filtered and dried resulting in the proppant coated material. In some embodiments, the thickness of the calcium alginate encapsulating coating 106 may be varied by varying the concentration of the calcium in the calcium lactate solution. In some embodiments, the use of a surfactant may improve the recovery of fracturing fluid and increase well productivity.

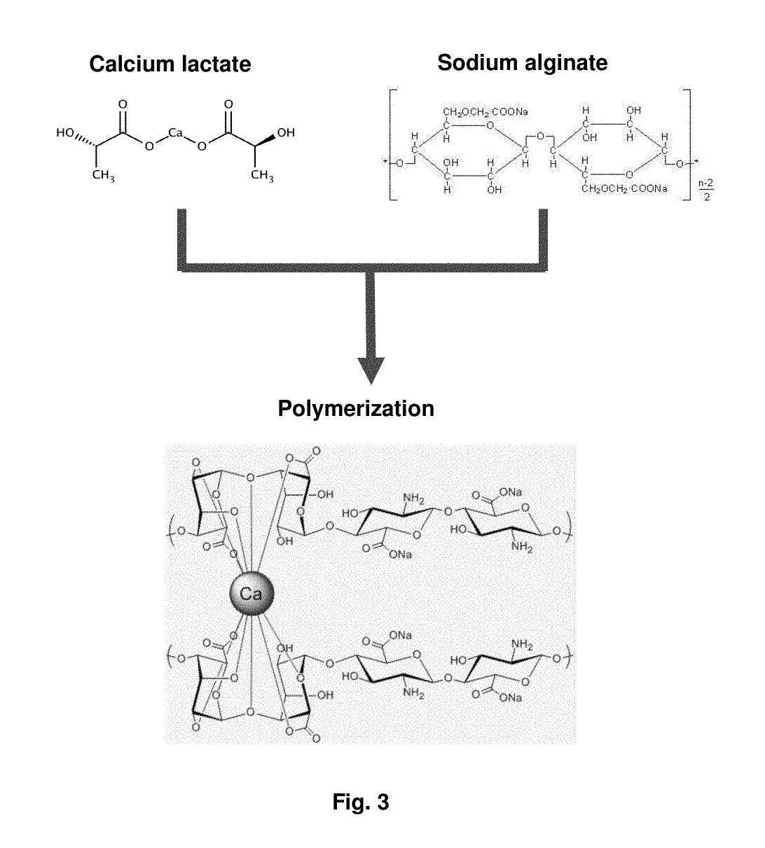

FIG. 3 depicts a schematic of the polymerization reaction of calcium lactate and sodium alginate that is used to create the encapsulating coating 106 used for some embodiments of the smart proppant platform technology 100. In some embodiments, a sodium alginate (0.5 wt. %) solution is added to calcium lactate (2.0 wt. %) solution by a titration method. In these embodiments, the polymerization encapsulates the liquids within a thin elastic exterior. Moreover, in these embodiments, calcium may generate the alginate molecules forming a water-insoluble material.

In other embodiments, the encapsulating coating 106 may be an inorganic soluble coating. In some embodiments, the encapsulating coating 106 may comprise a phosphate-based soluble glass, a water-soluble mineral, aluminosilicates, or metal oxide (i.e., CaO and MgO).

In some embodiments, the encapsulating coating 106 may comprise a soluble silicate. In some embodiments, the soluble silicate forming the encapsulating coating 106 may be selected from one or more of the following: Na₄SiO₄, Na₆Si₂O₇, N₃HSiO₄.5H₂O, Na₂SiO₃, Na₂SiO₃.5H₂O, Na₂SiO₃.1/2H₂O, Na₂SiO₃.8H₂O, Na₂SiO₃.9H₂O, Na₂Si₂O₅, Na₄Si₉O₉.7H₂O, K₂SiO₃, K₂SiO₃.1/2H₂O, K₂SiO₃.H₂O, K₂Si₂O₅, K₂Si₂O₅.H₂O, K₂Si₄O₉, K₂Si₄O₉.H₂O, NaLiSiO₃, Li₄SiO₄, Li₂SiO₃, Li₆Si₂O₇ and Li₂Si₂O₅.

In some embodiments, the encapsulating coating 106 may comprise an oxide that reacts with water (e.g. calcium oxide, magnesium oxide). In some embodiments, the metal oxide forming the encapsulating coating 106 may be selected from one or more of the following: Li₂O, Na₂O, K₂O, Rb₂O, Cs₂O, BeO, MgO, CaO, SrO and BaO.

In some embodiments, the encapsulating coating 106 may comprise a soluble aluminosilicate. In some embodiments, the soluble aluminosilicate forming the encapsulating coating 106 may be selected from: CaAl₂Si₂O and AlNaO₆Si₂.

In some embodiments, the encapsulating coating 106 may comprise a soluble mineral. In some embodiments, the soluble mineral forming the encapsulating coating 106 may be selected from: Aluminocopiapite, Amarantite, Aphthitalite, Apjohnite, Bandylite, Bararite, Bieberite, Bischofite, Blödite, Bobjonesite, Bobjonesite, Boothite, Borax, Boussingaultite, Burkeite, Caichengyunite, Caichengyunite, Caichengyunite, Carnallite, Chalcanthite, Chalcocyanite, Changoite, Cobaltkieserite, Cobaltkieserite, Copiapite, Coquimbite, Coskrenite-(Ce), Coskrenite-(Ce), Cryptohalite, Dorfmanite, Dorfmanite, Epsomite, Eriochalcite, Ferruccite, Goslarite, Halite, Halotrichite, Hanksite, Hibbingite, Hieratite, Hoganite, Hoganite, Hummerite, Ilesite, Inyoite, Julienne, Kalicinite, Kalinite, Kalinite, Koktaite, Koktaite, Konyaite, Kornelite, Kornelite, Kornelite, Kremersite, Lanmuchangite, Lecontite, Leonite, Letovicite, Levinsonite-(Y), Lopezite, Mascagnite, Melanterite, Mercallite, Morenosite, Nahcolite, Nitratine, Nitre, Paceite, Paracoquimbite, Penfieldite, Pickeringite, Picromerite, Picromerite, Potassium Alum, Probertite, Retgersite, Rinneite, Sal Ammoniac, Scacchite, Starkeyite, Stepanovite, Swaknoite, Sylvite, Tachyhydrite, Tamarugite, Teschemacherite, Thenardite, Thermonatrite, Trona, Tschermigite, Villiaumite, Voltaite, Wilcoxite, Zhemchuzhnikovite and Zugshunstite-(Ce).

In some embodiments, the encapsulating coating 106 may comprise a soluble glass. In some embodiments, the soluble glass forming the encapsulating coating 106 may be selected from: P₂O₅, CaO and Na₂O.

In some embodiments, the encapsulating coating 106 may comprise a soluble phosphate. In some embodiments, the soluble phosphates forming the encapsulating coating 106 may be selected from: sodium phosphate, potassium phosphate, rubidium phosphate, caesium phosphate and ammonium phosphate.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

1. A smart proppant platform technology comprising one or more of delivery vehicles, each delivery vehicle comprising:
a porous substrate;
an active agent that interacts with at least one constituent in an operating environment of a target location in which the delivery vehicle is deployed in such a way as to change a characteristic of the at least one constituent so as to facilitate a beneficial effect; and
a non-polymeric encapsulating coating, wherein the encapsulating coating is maintained until the delivery vehicle reaches the target location, wherein the operating environment of the target location causes the encapsulating coating to dissolve and release the active agent into the operating environment of the target location to facilitate the beneficial effect.

2. The smart proppant platform technology of claim 1, wherein the active agent is a surfactant.

3. The smart proppant platform technology of claim 1, wherein the active agent is a chelating agent, which captures both metal particles and dissolved metal ions from solution.

4. The smart proppant platform technology of claim 1, wherein the encapsulating coating comprises one or more of the following: a time release encapsulating coating, a water-soluble silicate coating, an oil soluble coating, a temperature sensitive coating, or an inorganic soluble coating.

5. The smart proppant platform technology of claim 1, wherein the active agent comprises one or more of the following: a chemically active agent, a biologically active agent, a surfactant, a biosurfactant, a catalyst for an in-situ reaction, a reactant for an in-situ reaction, or an environmentally friendly chemical.

6. The smart proppant platform technology of claim 1, wherein the proppant is surface modified.

7. The smart proppant platform technology of claim 1, wherein the proppant is treated with a pore former.

8. The smart proppant platform technology of claim 1, wherein the constituent is oil or natural gas in a hydraulically fractured subterranean feature.

9. The smart proppant platform technology of claim 8, wherein the active agent interacts with oil or natural gas to facilitate extraction from the hydraulically fractured subterranean feature.

10. The smart proppant platform technology of claim 5, wherein the active agent is an enzyme or biologically active agent that facilitates the remediation of fluorinated chemicals, solvents, and surfactants.

11. A method for fabricating a smart proppant delivery vehicle comprising:
mixing at least one oxide material and at least one mineral in the form of a slurry;
drying the slurry to form a dried powder; and
tumbling the dried powder to make substantially spherical particles;
mixing at least one other oxide material with the substantially spherical particles so as to form a coating of the other oxide on the substantially spherical particles;
sintering the coated spherical particles in a furnace with a reducing atmosphere at an elevated temperature for a predetermined period of time;
cooling the sintered substantially spherical particles to room temperature;
immersing the sintered substantially spherical particles in a solution comprising an active agent of interest or a precursor that can form an active agent; and
encapsulating the substantially spherical particles with a non-polymeric coating to form the smart proppant.

12. The method of claim 11, wherein the active agent is a surfactant.

13. The method of claim 11, wherein the active agent is a chelating agent, which captures both metal particles and dissolved metal ions from solution.

14. The method of claim 11, wherein the encapsulating coating comprises one or more of the following: a time release encapsulating coating, a water-soluble silicate coating, an oil soluble coating, a temperature sensitive coating, or an inorganic soluble coating.

15. The method of claim 11, wherein the active agent comprises one or more of the following: a chemically active agent, a biologically active agent, a surfactant, a biosurfactant, a catalyst for an in-situ reaction, a reactant for an in-situ reaction, or an environmentally friendly chemical.

16. The method of claim 11, wherein the proppant is surface modified.

17. The method of claim 11, wherein the proppant is treated with a pore former.

18. The method of claim 11, wherein the constituent is oil or natural gas in a hydraulically fractured subterranean feature.

19. The method of claims 11, wherein the active agent interacts with oil or natural gas to facilitate extraction from the hydraulically fractured subterranean feature.

20. The method of claims 11, wherein the active agent is an enzyme or biologically active agent that facilitates the remediation of fluorinated chemicals, solvents, and surfactants.
